(19) United States
(12) Patent Application Publication
(10) Pub. No.: US 2026/0094071 A1
(43) Pub. Date: Apr. 2, 2026

(54) MODEL LEARNING DEVICE, MODEL LEARNING METHOD, AND STORAGE MEDIUM STORING MODEL LEARNING PROGRAM

(71) Applicant: Mitsubishi Electric Corporation, Tokyo (JP)

(72) Inventors: Shoki MIYAGAWA, Tokyo (JP); Yuichi SASAKI, Tokyo (JP)

(73) Assignee: Mitsubishi Electric Corporation, Tokyo (JP)

(21) Appl. No.: 19/413,166

(22) Filed: Dec. 9, 2025

Related U.S. Application Data
(63) Continuation of application No. PCT/JP2023/024860, filed on Jul. 5, 2023.

(51) Int. Cl. G06N 20/00

(52) U.S. Cl. CPC G06N 20/00

(57) ABSTRACT

A model learning device includes processing circuitry to select fixed branches, as branches to be excluded from learning objects, to modify a calculation graph to be used into one of a first calculation graph that uses the plurality of branches and a second calculation graph that uses learning object branches obtained by excluding the fixed branches from the plurality of branches, to calculate inter-branch distances, including distances between features respectively generated by each of the plurality of branches, in a state in which the calculation graph to be used has been modified to the first calculation graph, to calculate a sum total of losses based on a predetermined loss function and the inter-branch distances, and to update weight parameters in the learning object branches based on the sum total of losses in a state in which the calculation graph to be used has been modified to the second calculation graph.

### CROSS-REFERENCE TO RELATED APPLICATION

This application is a continuation application of International Application No. PCT/JP2023/024860 having an international filing date of Jul. 5, 2023, which is hereby expressly incorporated by reference into the present application.

### BACKGROUND OF THE INVENTION

### 1. Field of the Invention

The present disclosure relates to a model learning device, a model learning method and a model learning program.

### 2. Description of the Related Art

In cases such as when the amount of learning data is small in machine learning, when a difficult problem setting has been made as in weakly supervised learning, or the like, there is a possibility of learning a feature undesirable for a human. Even though it is possible to determine whether a learned feature is appropriate or not (e.g., to check whether an undesirable feature has been obtained or not) through visualization by XAI (Explainable AI), it is difficult to provide feedback (e.g., execute transfer learning) so that a learning model does not learn an inappropriate feature. Therefore, as a method for providing feedback so that the learning model does not learn an inappropriate feature, there has been proposed a model learning method in which the learning of features that should be obtained is controlled by modifying a loss function in regard to each piece of data by relearning attention obtained by the learning, and the transfer learning is repeated until a desirable feature is obtained (see Patent Reference 1, for example).
Patent Reference 1: Japanese Patent Application Publication No. 2022-79331.

In the above-described conventional model learning method, it is necessary to repeat the transfer learning until a feature desirable for a human is obtained, and there is a possibility of obtaining again a feature already learned in the past since the transfer learning is repeated anew without memorizing features already obtained in the past. Therefore, the conventional model learning method has a problem of being inefficient.

### SUMMARY OF THE INVENTION

An object of the present disclosure, which has been made to resolve the above-described problems with the conventional technology, is to provide a model learning device, a model learning method and a model learning program that make it possible to increase the efficiency of the model learning.

A model learning device in the present disclosure is a device that executes transfer learning in regard to a learning model stored in storage. The model learning device includes a fixed branch selection unit to select fixed branches, as branches to be excluded from learning objects, from a plurality of branches included in the learning model; a calculation graph modification unit to modify a calculation graph to be used into one of a first calculation graph that uses the plurality of branches and a second calculation graph that uses learning object branches obtained by excluding the fixed branches from the plurality of branches; an inter-branch distance calculation unit to calculate inter-branch distances, including distances between features respectively generated by each of the plurality of branches, in a state in which the calculation graph to be used has been modified to the first calculation graph; a loss function calculation unit to calculate a sum total of losses based on a predetermined loss function and the inter-branch distances; and a branch update unit to update weight parameters in the learning object branches based on the sum total of losses in a state in which the calculation graph to be used has been modified to the second calculation graph.

A model learning method in the present disclosure is a method to be executed by a model learning device that executes transfer learning in regard to a learning model stored in storage. The model learning method includes a step of selecting fixed branches, as branches to be excluded from learning objects, from a plurality of branches included in the learning model, a step of modifying a calculation graph to be used into one of a first calculation graph that uses the plurality of branches and a second calculation graph that uses learning object branches obtained by excluding the fixed branches from the plurality of branches, a step of calculating inter-branch distances, including distances between features respectively generated by each of the plurality of branches, in a state in which the calculation graph to be used has been modified to the first calculation graph, a step of calculating a sum total of losses based on a predetermined loss function and the inter-branch distances, and a step of updating weight parameters in the learning object branches based on the sum total of losses in a state in which the calculation graph to be used has been modified to the second calculation graph.

According to the present disclosure, the efficiency of the model learning can be increased.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically showing the configuration of a model learning device according to a first embodiment;

FIG. 2 is a diagram showing an example of the hardware configuration of the model learning device according to the first embodiment;

FIG. 3 is a schematic diagram showing the operation of the model learning device according to the first embodiment;

FIG. 4 is a schematic diagram showing the operation of a model learning device as a comparative example;

FIG. 5 is an explanatory diagram showing the operation of a model learning unit at the time of forward propagation;

FIG. 6 is an explanatory diagram showing the operation of the model learning unit at the time of error back propagation;

FIG. 7 is a flowchart showing the operation of the model learning device according to the first embodiment;

FIG. 8 is a flowchart showing the operation of the model learning device according to the first embodiment at the time of model learning;

FIG. 9 is a block diagram schematically showing the configuration of a model learning device according to a second embodiment;

FIG. 10 is a diagram showing an example of the hardware configuration of the model learning device according to the second embodiment;

FIG. 11 is a flowchart showing the operation of the model learning device according to the second embodiment at the time of model learning;

FIG. 12 is a block diagram schematically showing the configuration of a model learning device according to a third embodiment;

FIG. 13 is a diagram showing an example of the hardware configuration of the model learning device according to the third embodiment;

FIG. 14 is a flowchart showing the operation of the model learning device according to the third embodiment at the time of model learning;

FIG. 15 is a block diagram schematically showing the configuration of a model learning device according to a fourth embodiment;

FIG. 16 is a diagram showing an example of the hardware configuration of the model learning device according to the fourth embodiment; and

FIG. 17 is a flowchart showing the operation of the model learning device according to the fourth embodiment at the time of model learning.

### DETAILED DESCRIPTION OF THE INVENTION

A model learning device, a model learning method and a model learning program according to each embodiment will be described below with reference to the drawings. The following embodiments are just examples and it is possible to appropriately combine embodiments and appropriately modify each embodiment.

### <1> First Embodiment

### <1-1> Configuration

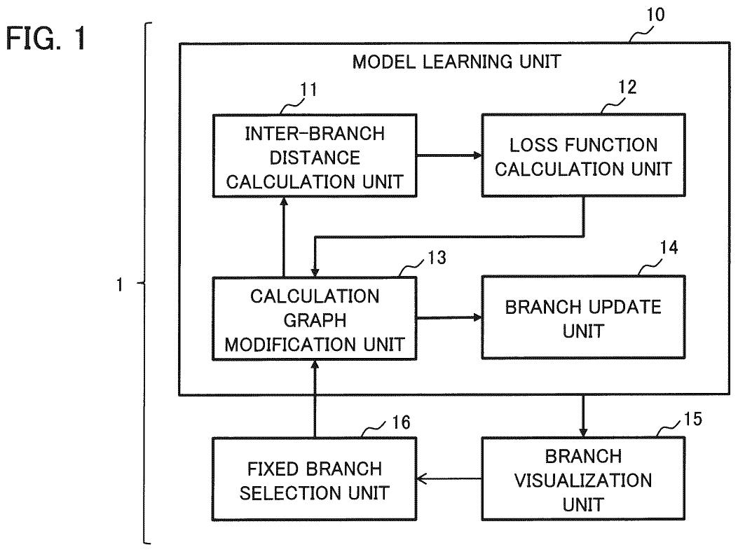

FIG. 1 is a block diagram schematically showing the configuration of a model learning device 1 according to a first embodiment. The model learning device 1 is a device capable of executing a model learning method according to the first embodiment, such as a computer executing a model learning program according to the first embodiment, for example. The model learning device 1 according to the first embodiment includes a model learning unit 10, a branch visualization unit 15 and a fixed branch selection unit 16. The model learning unit 10 includes an inter-branch distance calculation unit 11, a loss function calculation unit 12, a calculation graph modification unit 13 and a branch update unit 14. Incidentally, one or both of the fixed branch selection unit 16 and the branch visualization unit 15 can also be a part of the model learning unit 10.

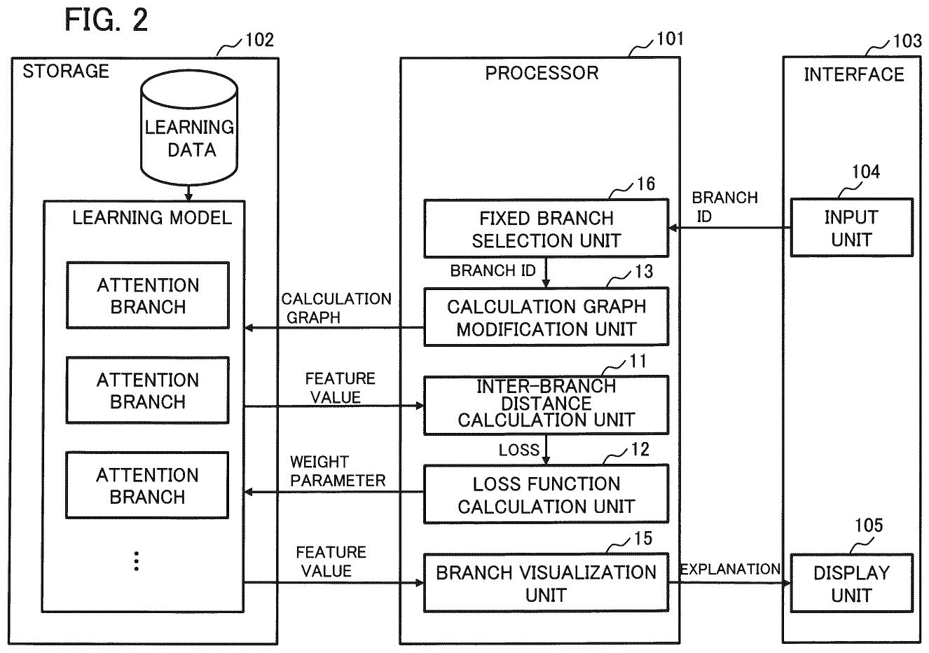

FIG. 2 is a diagram showing an example of the hardware configuration of the model learning device 1 according to the first embodiment. The model learning device 1 includes, for example, a processor 101 such as a CPU (Central Processing Unit), storage 102 as a storage device, and an interface 103. Parts forming the model learning device 1 are formed with processing circuitry, for example. The processing circuitry can either be dedicated hardware or include a CPU that executes a program (e.g., model learning program) stored in the storage 102. The processor 101 implements functional blocks shown in FIG. 1.

The storage 102 includes, for example, a semiconductor memory such as a RAM (Random Access Memory) and a nonvolatile storage device such as an HDD (Hard Disk Drive). Further, the model learning device 1 can be a mixture of components made with processing circuitry and components made with a processor. Furthermore, part or the whole of the model learning device 1 can be a server computer on a network. The model learning program is provided by means of downloading via a network or through a storage medium storing information such as a USB memory. The storage medium is a non-transitory computer-readable storage medium storing the model learning program.

In the example in FIG. 2, the storage 102 has stored a learning model and learning data to be used for learning. The learning model includes a plurality of attention branches (also referred to simply as “branches”). The interface 103 includes an input unit (i.e., input device) 104 as a user interface through which user operations are performed and a display unit 105 that presents information such as a liquid crystal display. The hardware configuration in FIG. 2 is just an illustration and thus modification is possible.

In FIG. 1 and FIG. 2, the fixed branch selection unit 16 of the model learning device 1 executes transfer learning in regard to the learning model stored in the storage 102. Fixed branches as branches to be excluded from learning objects (i.e., branches in each of which a weight parameter is fixed) are selected from the plurality of branches included in the learning model. Identification information regarding the fixed branches is inputted through, for example, the input unit 104 on which operations for inputting operations by a user is performed.

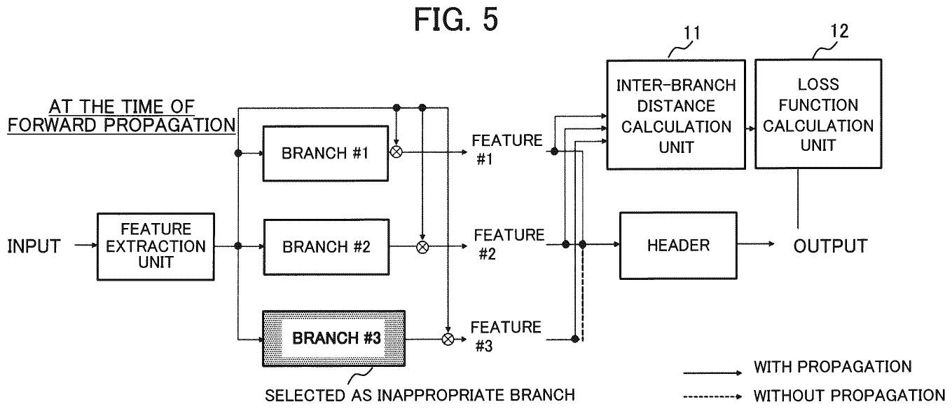

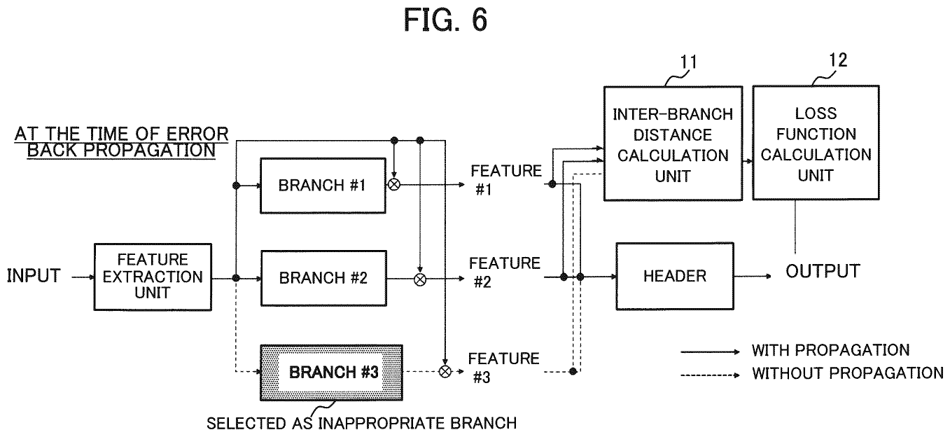

The calculation graph modification unit 13 in the model learning unit 10 modifies a calculation graph to be used into one of a first calculation graph that uses the plurality of branches included in the learning model (i.e., a calculation graph corresponding to a configuration at the time of forward propagation shown in FIG. 5 which will be explained later) and a second calculation graph that uses learning object branches obtained by excluding the fixed branches from the plurality of branches included in the learning model (i.e., a calculation graph corresponding to a configuration at the time of error back propagation shown in FIG. 6 which will be explained later).

The inter-branch distance calculation unit 11 in the model learning unit 10 calculates inter-branch distances, including distances between features respectively generated by each of the plurality of branches included in the learning model, in a state in which the calculation graph to be used in the learning has been modified to the first calculation graph (i.e., the calculation graph corresponding to the configuration at the time of forward propagation). The inter-branch distances calculated by the inter-branch distance calculation unit 11 can include distances respectively between each of the features and the feature of a predetermined target branch, in addition to the distances between the features respectively generated by each of the plurality of branches included in the learning model.

The loss function calculation unit 12 in the model learning unit 10 calculates a sum total of losses based on a predetermined loss function and the inter-branch distances.

The branch update unit 14 in the model learning unit 10 updates the weight parameter in each learning object branch based on the sum total of losses obtained by the loss function calculation unit 12 in a state in which the calculation graph to be used in the learning has been modified to the second calculation graph (i.e., the calculation graph corresponding to the configuration at the time of error back propagation).

The branch visualization unit 15 visualizes the feature generated by each of the plurality of branches included in the learning model. Specifically, the branch visualization unit 15 transmits the feature to the display unit 105 and makes the display unit 105 display the feature.

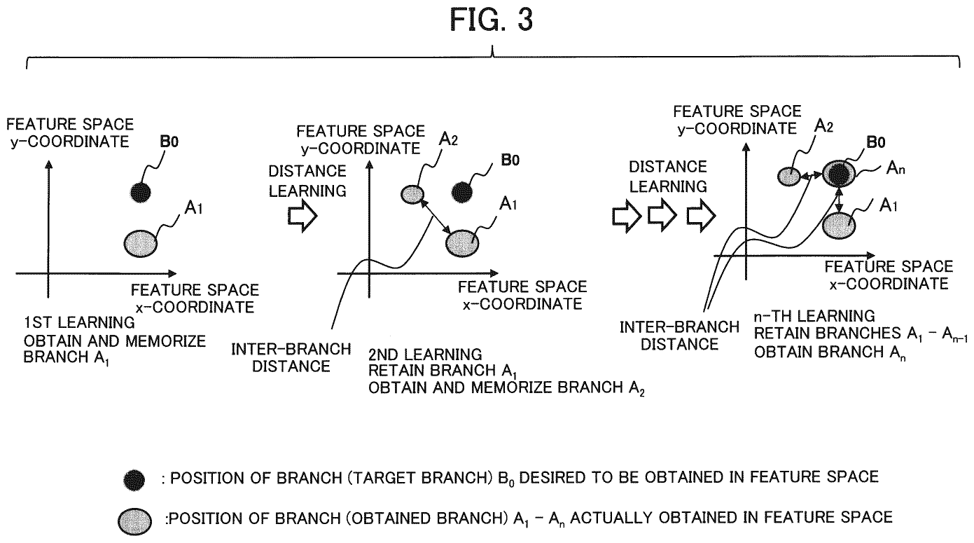

FIG. 3 is a schematic diagram showing the operation of the model learning device 1 according to the first embodiment. The model learning device 1 obtains features already learned in the past in units of branches A₁, A₂, . . . , Aₙ (n: positive integer), memorizes the obtained branches, and learns new features at the time of the transfer learning by learning the inter-branch distance. By repeating the inter-branch distance learning (e.g., distance learning between each obtained branch and the target branch and distance learning between obtained branches) each time a new feature is obtained by learning the inter-branch distance at the time of the transfer learning as above, the number of times of the transfer learning necessary until an appropriate feature (i.e., a branch Aₙ overlapping with the target branch B₀ in a feature space shown in FIG. 3) is obtained can be reduced. In this case, the model learning device 1 memorizes the obtained branches regarding undesirable features obtained in the past and considers the inter-branch distances and is thereby capable of executing the learning while feeding back and making the most of the results of past transfer learning processes.

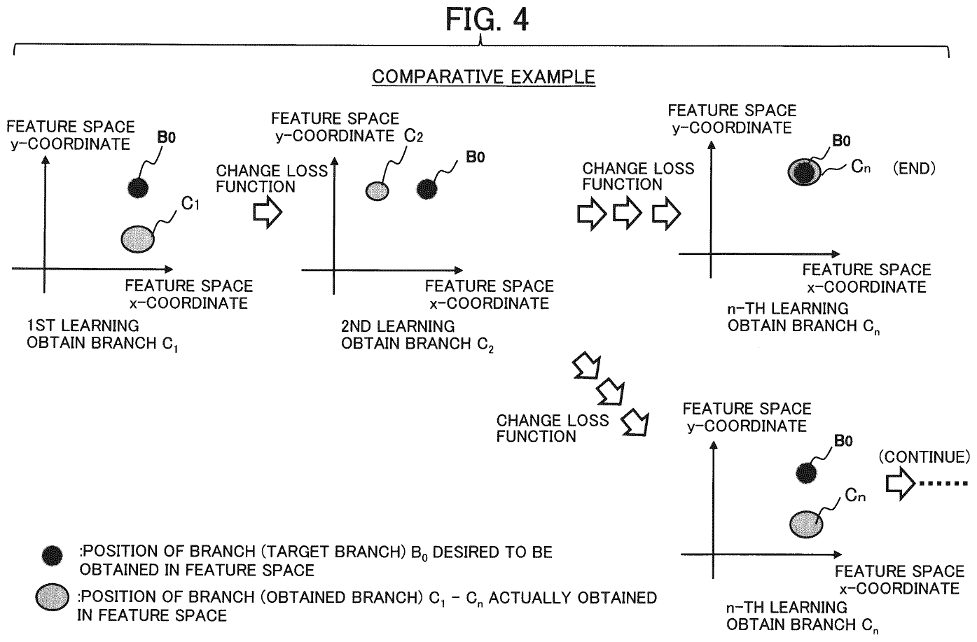

FIG. 4 is a schematic diagram showing the operation of a model learning device as a comparative example. The model learning device as the comparative example obtains learned features in units of branches C₁, C₂, . . . , Cₙ (n: positive integer) while changing the loss function in regard to each piece of data at the time of the transfer learning and repeats the transfer learning, and thereby repeats the transfer learning until an appropriate feature (i.e., a branch Cₙ overlapping with the target branch B₀ in a feature space shown in FIG. 4) is obtained. In this case, it is impossible to make use of the obtained branches regarding undesirable features obtained in the past since the obtained branches regarding undesirable features obtained in the past have not been memorized. In this case, there is a possibility of learning again a branch regarding an undesirable feature, and inefficient model learning is executed.

FIG. 5 is an explanatory diagram showing the operation of the model learning unit 10 at the time of forward propagation. FIG. 5 shows a case where the calculation graph modification unit 13 in the model learning unit 10 handles a branch #1 and a branch #2 as the learning object branches and handles a branch #3 as the fixed branch (i.e., a branch excluded from the learning objects by the fixed branch selection unit 16). At the time of forward propagation, while features #1, #2 and #3 are respectively generated from the branches #1, #2 and #3, the calculation graph modification unit 13 inputs the features #1 and #2 to a header without inputting the feature #3 to the header since a command for excluding the feature #3 from the learning objects because the feature #3 is an inappropriate feature undesirable for a human has been inputted to the fixed branch selection unit 16. On the other hand, since the feature #1 and the feature #2 should be learned as features at long distances from the feature #3, the calculation graph modification unit 13 inputs all the features including the features #1, #2 and #3 to the inter-branch distance calculation unit 11.

FIG. 6 is an explanatory diagram showing the operation of the model learning unit 10 at the time of error back propagation. FIG. 6 shows a case where the calculation graph modification unit 13 in the model learning unit 10 handles the branch #1 and the branch #2 as the learning object branches and handles the branch #3 as the fixed branch. At the time of error back propagation, a command for handling the branch #3 as the fixed branch has been inputted to the fixed branch selection unit 16, and thus the calculation graph modification unit 13 removes input and output edges of the branch #3 from the calculation graph in order to exclude the branch #3 from the learning objects. Therefore, the calculation graph modification unit 13 inputs the features #1 and #2 to the inter-branch distance calculation unit 11 but does not input the feature #3 generated by the fixed branch to the inter-branch distance calculation unit 11.

As described above, in the first embodiment, the calculation graph at the time of forward propagation and the calculation graph at the time of error back propagation differ from each other. Namely, the features #1-#3 of all branches, including the feature #3 of the fixed branch, are outputted to the inter-branch distance calculation unit 11 when obtaining the sum total of losses based on the inter-branch distances, whereas the features #1-#2 of branches, excluding the feature #3 of the fixed branch, are outputted to the inter-branch distance calculation unit 11 when making the branch update.

### <1-2> Operation

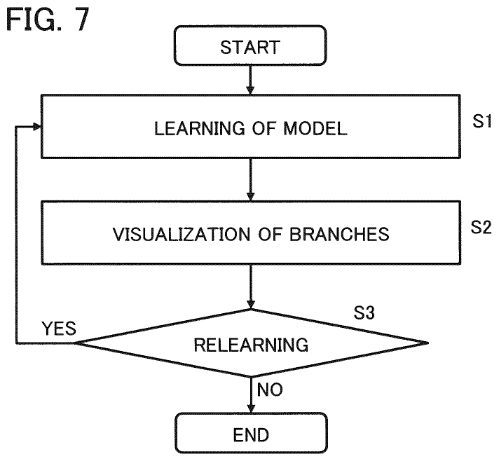

FIG. 7 is a flowchart showing the operation of the model learning device 1 according to the first embodiment at the time of model learning. In the first embodiment, first, the model learning unit 10 learns the model by using learning data (e.g., the learning data in the storage 102 in FIG. 2) (step S1).

Subsequently, the branch visualization unit 15 visualizes the feature obtained by each branch by using XAI and makes the display unit (e.g., the display unit 105 in FIG. 2) present the visualization result to be interpretable by a human (step S2). In this case, it is also possible to display the visualization result by using a BI (Business Intelligence) tool or a dedicated GUI (Graphical User Interface). As the XAI, there exist local explanation (e.g., explanation in regard to each piece of data) and global explanation (e.g., explanation of behavior of a model). Explanation (attention) in regard to each local part is used as the XAI in the conventional technology, whereas in the first embodiment, either of the local explanation and the global explanation may be used as the XAI and it is also possible to use both of the local explanation and the global explanation. The user views the visualization result, and when the exclusion of a branch is necessary, inputs the identification information on the fixed branch as a branch that should be excluded (i.e., branch ID) to the fixed branch selection unit 16 by using the input unit 104 in FIG. 2, for example.

When the feature learned by each branch falls into a predetermined condition, namely, a first case or a second case described below, based on the result of a human's interpretation of the feature learned by each branch, the fixed branch selection unit 16 fixes the weight parameter of the branch that obtained the feature falling into the first case or the second case and excludes the feature falling into the first case or the second case from the objects of the learning.

The first case is a case where the feature generated by the branch by the learning is a feature undesirable for a human. Since the feature in the first case is not used for inference after the learning, the branch learning the feature in the first case is designated as a fixed branch and excluded from the learning objects in order to avoid the relearning of the feature in the first case.

The second case is a case where the feature generated by the branch by the learning is a feature desirable for a human. Although the feature in the second case is used for the inference after the learning, the branch learning the feature in the second case is designated as a fixed branch and excluded from the objects of the learning in order to make it possible to retain the feature in the second case even if the transfer learning is executed.

The model learning unit 10 judges whether relearning is necessary or not, and returns the process to the step S1 if the relearning is necessary (YES in step S3), or ends the process if the relearning is unnecessary (NO in the step S3).

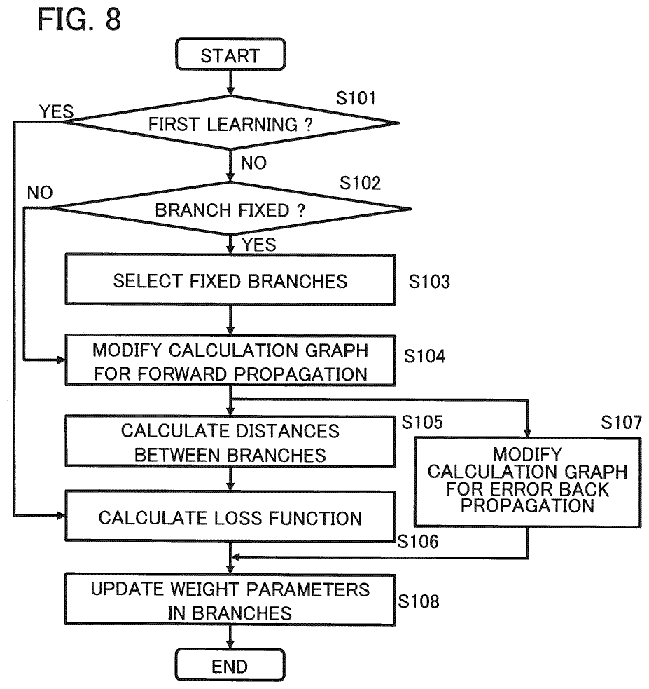

FIG. 8 is a flowchart showing the operation of the model learning device 1 according to the first embodiment at the time of model learning (i.e., details of the step S1 in FIG. 7). First, the model learning unit 10 judges whether the learning to be executed is the first learning or not, and if the learning is the first learning (YES in step S101), advances the process to step S106, in which the loss function calculation unit 12 calculates the loss function. When the second or later model learning is executed (NO in the step S101), the model learning unit 10 advances the process to step S102.

In the step S102, the model learning unit 10 judges whether or not there exists a fixed branch whose weight parameter is fixed as a branch to be used for obtaining a feature of the data. If there exists a fixed branch (YES in the step S102), the model learning unit 10 advances the process from the step S102 to step S103 and makes the selection of the fixed branches. If there exists no fixed branch (NO in the step S102), the model learning unit 10 advances the process from the step S102 to step S104.

In the step S104, the calculation graph modification unit 13 in the model learning unit 10 modifies the calculation graph for the purpose of forward propagation. As shown in FIG. 5, at the time of forward propagation, an edge from the input to the branch #3 as the fixed branch is set valid, an edge from the branch #3 to the inter-branch distance calculation unit 11 is set valid, and an edge from the branch #3 to the header is set invalid.

In step S105, the inter-branch distance calculation unit 11 in the model learning unit 10 calculates the distances between branches. In this case, the inter-branch distance calculation unit 11 calculates the inter-branch distances in order to learn branches different from branches learned in the past. The inter-branch distance calculation unit 11 calculates the following two types of distances: a first distance and a second distance, as the inter-branch distances:

The first distance is the distance between a feature generated by a learning object branch and a feature generated by a fixed branch. The first distance is desired to be long in order to learn features different from features learned in the past.

The second distance is the distance between features respectively generated by learning object branches. The second distance is desired to be long in order to make features, simultaneously obtained by a plurality of learning object branches (i.e., newly obtained branches), be dissimilar to each other. The second distance does not exist when the number of learning object branches is 1.

Here, the distance may be freely defined by the user. For example, in ArcFace as a deep distance learning (deep metric learning) method, the cosine similarly between features mapped on a hypersphere is defined as the distance.

In the next step S106, the loss function calculation unit 12 in the model learning unit 10 calculates the sum total of losses by using a previously determined loss function. The loss function is defined as the sum of a loss dependent on the task and a distance loss dependent on the inter-branch distance calculation unit 11 (i.e., the sum total of losses), and is represented by the following expression (1):

$$( sum total of losses ) = ( loss dependent on task ) + ( β \times ( distance loss ) ) . \qquad ( 1 )$$

Since the number of terms included in the distance loss varies depending on the result of the selection by the fixed branch selection unit 16, the hyperparameter β is adjusted (or normalized) depending on the balance with the loss dependent on the task.

When the number of fixed branches is “a” and the number of learning object branches is “b”, there exist as many terms as the number represented by the following expression (2):

$$a * b + {}_{b} {C}_{2} . \qquad ( 2 )$$

In the expression (2), the first term represents the number of combinations of a fixed branch and a learning object branch, and the second term represents the number of combinations between learning object branches.

In step S107, the calculation graph modification unit 13 in the model learning unit 10 modifies the calculation graph for the purpose of error back propagation. As shown in FIG. 6, at the time of error back propagation, the edge from the input to the branch #3 as the fixed branch is set invalid, the edge from the branch #3 to the inter-branch distance calculation unit 11 is set invalid, and the edge from the branch #3 to the header is set invalid.

In step S108, the branch update unit 14 in the model learning unit 10 updates the weight parameters in the learning object branches.

### <1-3> Effect

With the model learning device 1 according to the first embodiment, the learning can be started with a small number of branches, and thus overtraining can be inhibited and speeding up of the learning can be realized.

### <2> Second Embodiment

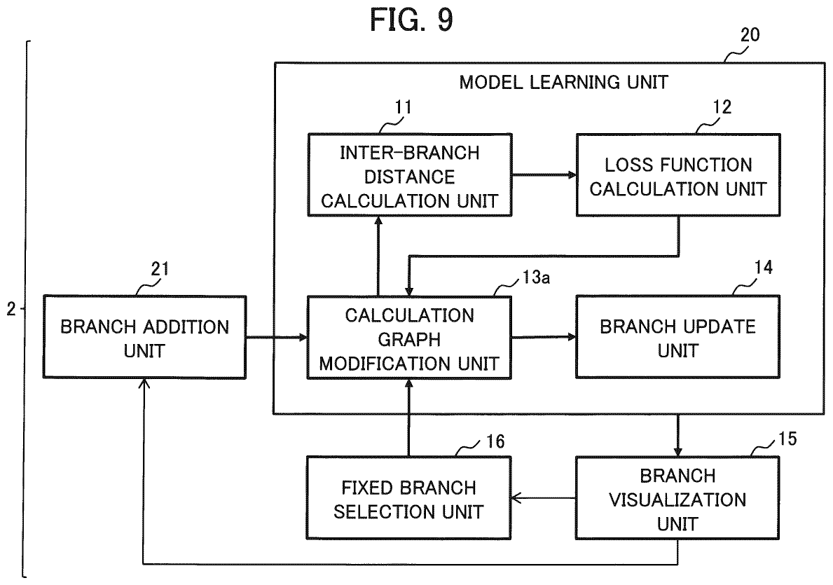

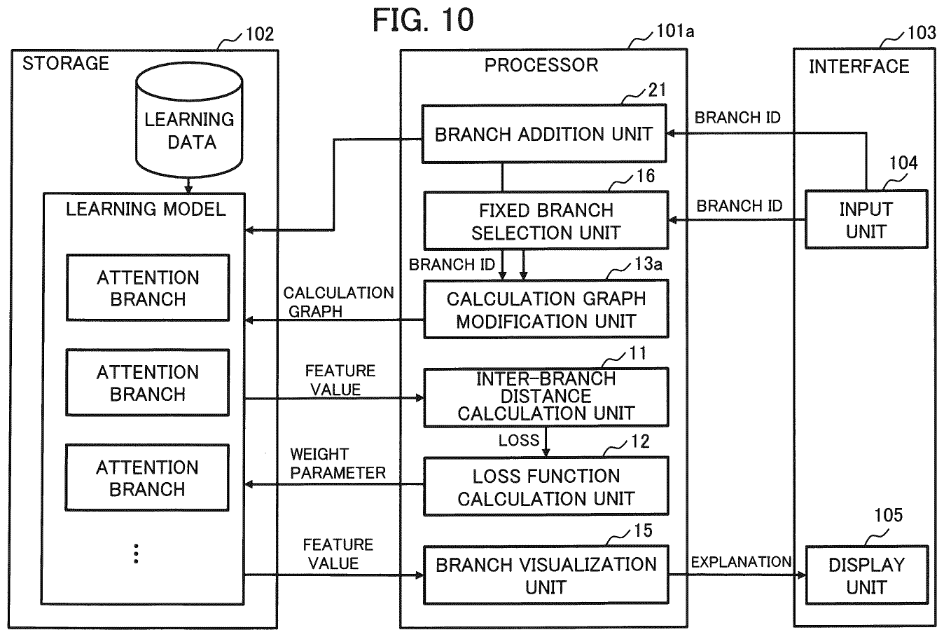

FIG. 9 is a block diagram schematically showing the configuration of a model learning device 2 according to a second embodiment. In FIG. 9, each component identical or corresponding to a component shown in FIG. 1 is assigned the same reference character as in FIG. 1. FIG. 10 is a diagram showing an example of the hardware configuration of the model learning device 2 according to the second embodiment. In FIG. 10, each component identical or corresponding to a component shown in FIG. 2 is assigned the same reference character as in FIG. 2. The model learning device 2 is a device capable of executing a model learning method according to the second embodiment, such as a computer executing a model learning program according to the second embodiment, for example.

The model learning device 2 according to the second embodiment differs from the model learning device 1 according to the first embodiment in including a branch addition unit 21 and in that a calculation graph modification unit 13a modifies the calculation graph based on the branches plus branches provided from the branch addition unit 21.

In general, the learning that is executed in a state of having prepared a lot of branches in the learning model needs to use a lot of weight parameters, and thus the level of difficulty is high, the overtraining is likely to occur, or the processing time is long. Thus, there are cases where it is desirable to execute the learning in the initial stage by use of a small number of learning object branches capable of learning and thereafter increase the number of learning object branches by making the branch addition unit 21 add branches to the learning model. Since the number of learning object branches used by the fixed branch selection unit 16 decreases as the transfer learning is repeated, in the model learning device 2 according to the second embodiment, learning object branches are added later by the branch addition unit 21 as needed.

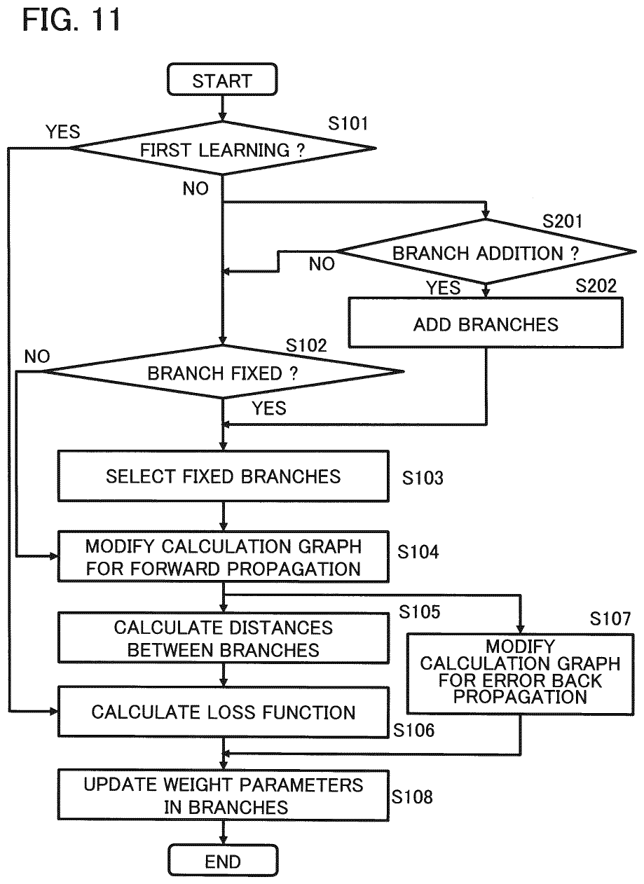

FIG. 11 is a flowchart showing the operation of the model learning device 2 according to the second embodiment at the time of model learning. In FIG. 11, each step identical or corresponding to a step shown in FIG. 8 is assigned the same reference character as in FIG. 8. The operation of the model learning device 2 at the time of model learning differs from the operation of the model learning device 1 according to the first embodiment at the time of model learning in further including step S201 of judging whether the branch addition by the branch addition unit 21 should be made or not and step S202 in which the branch addition unit 21 adds branches to a model learning unit 20 in the case of making the branch addition and in that the model learning unit 20 executes the processing in the steps S104 to S107 by using learning object branches including the added branches.

With the model learning device 2 according to the second embodiment, the learning can be started with a small number of branches, and thus the overtraining can be inhibited and the speeding up of the learning can be realized.

Further, with the model learning device 2 according to the second embodiment, the branch visualization unit 15 visualizes the feature obtained by each branch by use of XAI and the user is capable of adding branches whose weight parameters have been appropriately initialized to the learning model through the branch addition unit 21, and thus the accuracy of the learning can be increased.

Except for the above-described features, the second embodiment is the same as the first embodiment.

### <3> Third Embodiment

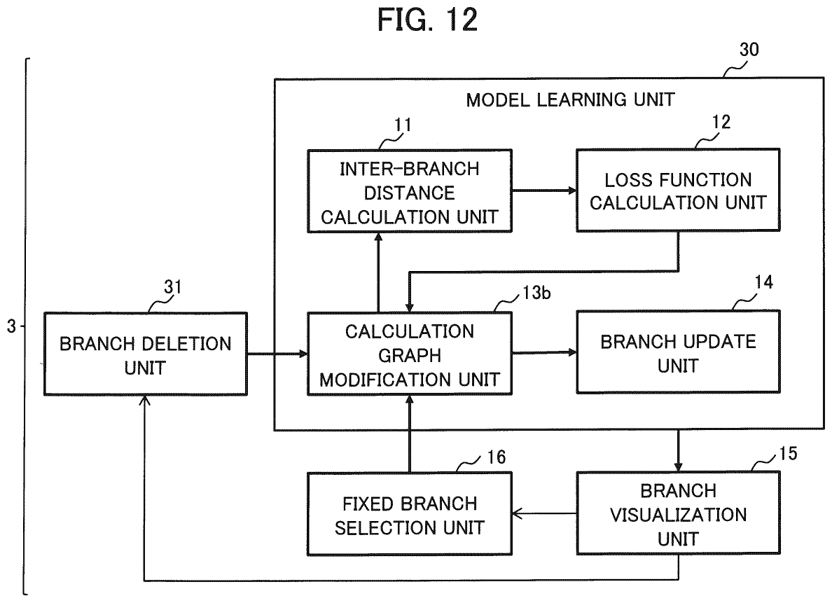

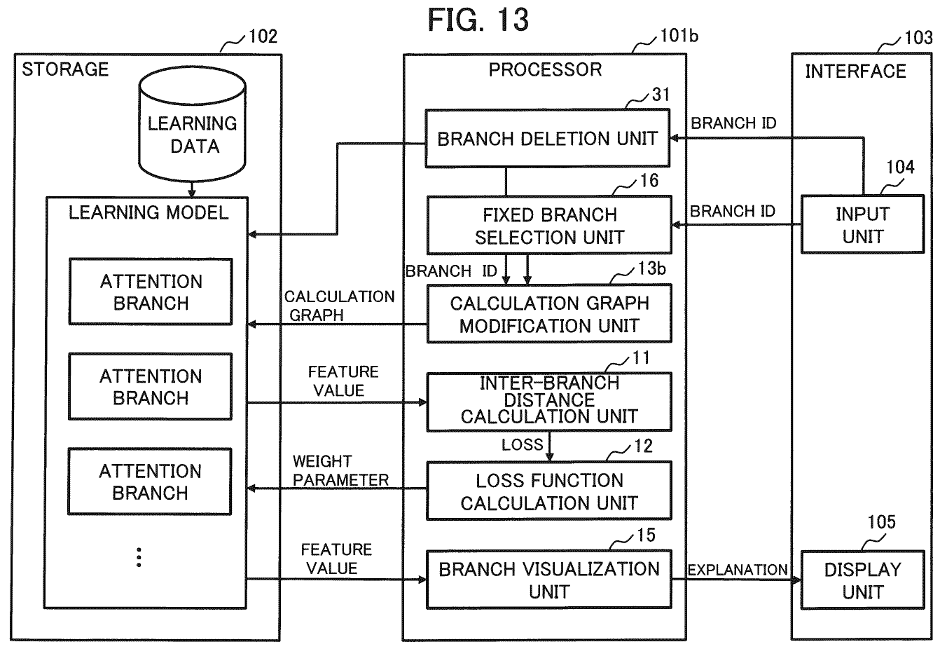

FIG. 12 is a block diagram schematically showing the configuration of a model learning device 3 according to a third embodiment. In FIG. 12, each component identical or corresponding to a component shown in FIG. 1 is assigned the same reference character as in FIG. 1. FIG. 13 is a diagram showing an example of the hardware configuration of the model learning device 3 according to the third embodiment. In FIG. 13, each component identical or corresponding to a component shown in FIG. 2 is assigned the same reference character as in FIG. 2. The model learning device 3 is a device capable of executing a model learning method according to the third embodiment, such as a computer executing a model learning program according to the third embodiment, for example.

The model learning device 3 according to the third embodiment differs from the model learning device 1 according to the first embodiment in including a branch deletion unit 31 and in that a calculation graph modification unit 13b modifies the calculation graph based on the branches from which branches designated by the branch deletion unit 31 have been deleted.

In general, in a maintenance/operation stage after finishing the learning of the model, branches that learned inappropriate features are remaining in the memory. In cases where the number of branches is large, the time necessary for making the inference by using the model becomes long and the use amount of the memory by the branches increases. Thus, the model learning device 3 according to the third embodiment includes the branch deletion unit 31 and is configured to be able to delete branches selected by the user based on the definition of the model and the weight parameters. Incidentally, at the time of the deletion, a backup of the deleted branches may be made since there can occur a case of learning the branches again.

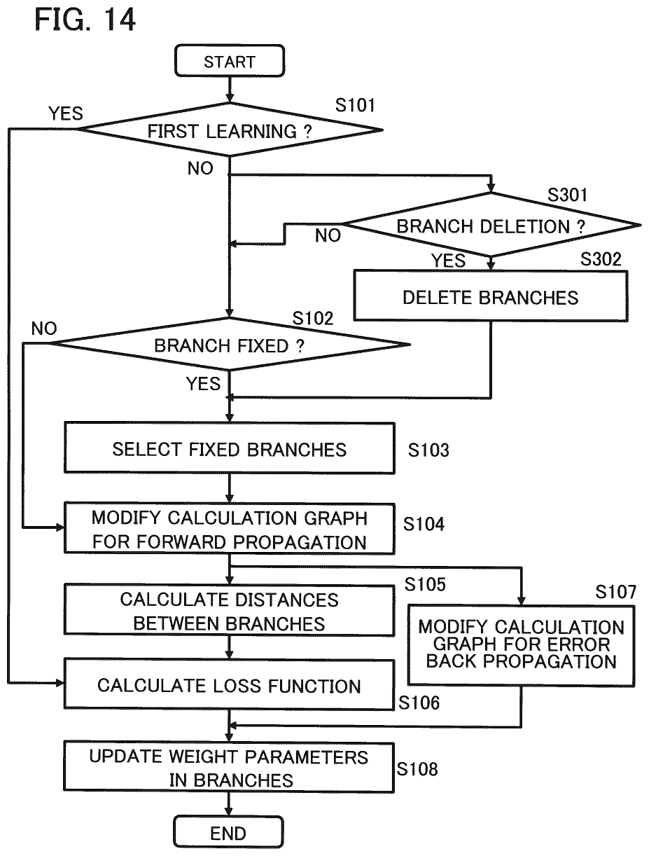

FIG. 14 is a flowchart showing the operation of the model learning device 3 according to the third embodiment at the time of model learning. In FIG. 14, each step identical or corresponding to a step shown in FIG. 8 is assigned the same reference character as in FIG. 8. The operation of the model learning device 3 at the time of model learning differs from the operation of the model learning device 1 according to the first embodiment at the time of model learning in further including step S301 of judging whether the branch deletion by the branch deletion unit 31 should be made or not and step S302 in which the branch deletion unit 31 deletes branches from a model learning unit 30 in the case of making the branch deletion and in that the model learning unit 30 executes the processing in the steps S104 to S107 by using the learning object branches excluding the deleted branches.

With the model learning device 3 according to the third embodiment, the branch visualization unit 15 visualizes the feature obtained by each branch by use of XAI and the user is capable of deleting branches through the branch deletion unit 31, and thus the accuracy of the learning can be increased, by which reduction of the memory use amount and speeding up of the inference can be realized.

Except for the above-described features, the third embodiment is the same as the first embodiment. Further, it is also possible to apply the branch deletion unit 31 in the third embodiment to the model learning device 2 in the second embodiment.

### <4> Fourth Embodiment

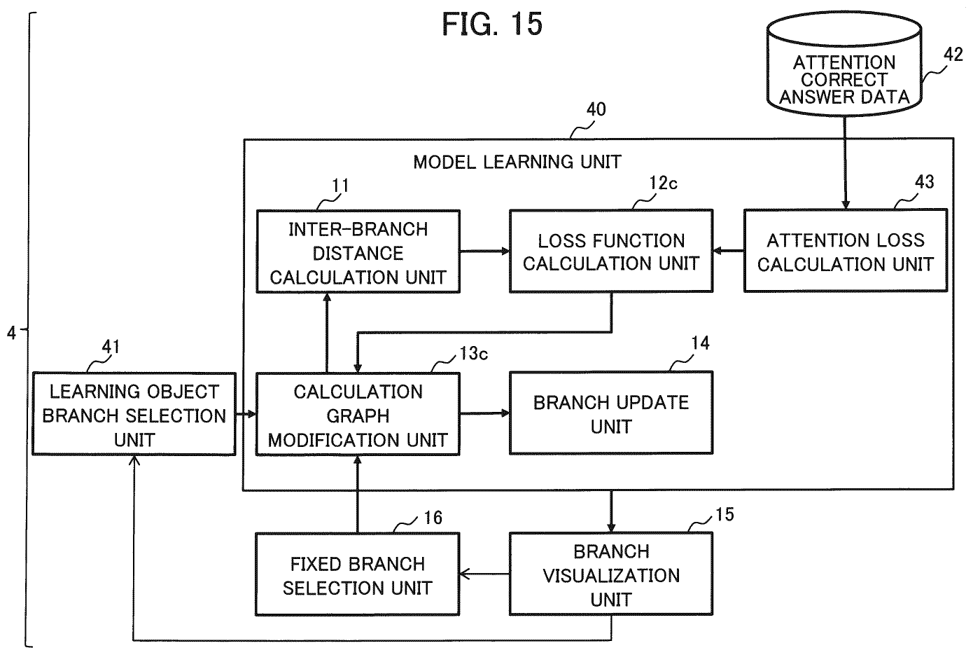

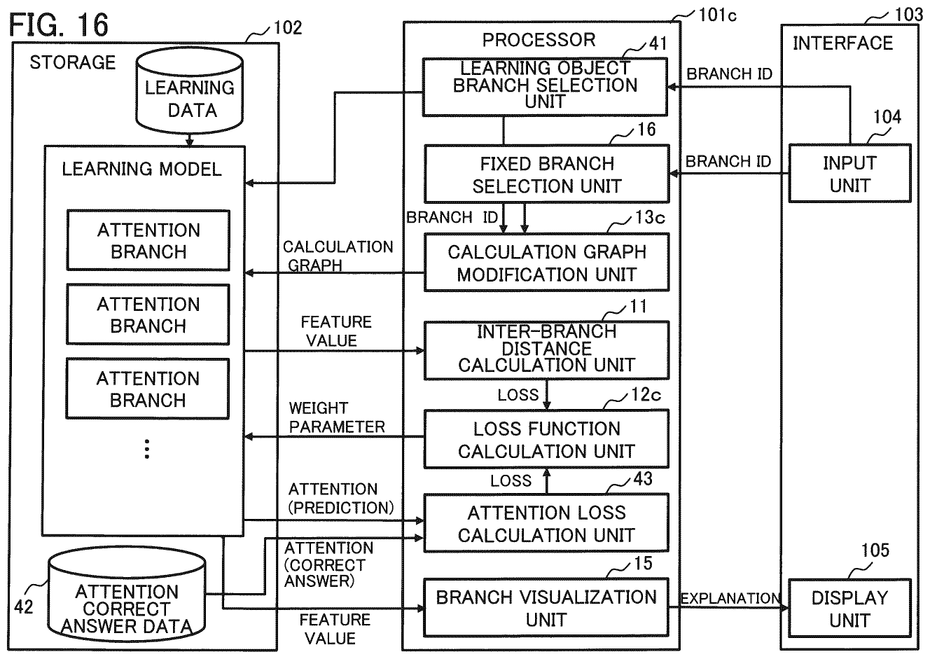

FIG. 15 is a block diagram schematically showing the configuration of a model learning device 4 according to a fourth embodiment. In FIG. 15, each component identical or corresponding to a component shown in FIG. 1 is assigned the same reference character as in FIG. 1. FIG. 16 is a diagram showing an example of the hardware configuration of the model learning device 4 according to the fourth embodiment. In FIG. 16, each component identical or corresponding to a component shown in FIG. 2 is assigned the same reference character as in FIG. 2. The model learning device 4 is a device capable of executing a model learning method according to the fourth embodiment, such as a computer executing a model learning program according to the fourth embodiment, for example.

The model learning device 4 according to the fourth embodiment differs from the model learning device 1 according to the first embodiment in including a learning object branch selection unit 41, attention correct answer data 42 and an attention loss calculation unit 43 and in that a calculation graph modification unit 13c modifies the calculation graph based on learning object branches designated by the learning object branch selection unit 41 and a loss function calculation unit 12c modifies the calculation of the loss function based on the attention loss calculation unit 43.

In the fourth embodiment, the learning of features that should be obtained is controlled by modifying the loss function in regard to each piece of data by directly correcting the attention obtained by the learning. For example, the model learning device 4 selects a particular learning object branch and makes the branch execute the learning so as to generate attention close to attention corrected by a human. In such cases where a feature likely to be mistaken is previously known, the necessary number of times of the transfer learning can be reduced by purposely preparing data of such attention and having the data learned. Further, in cases where such a feature likely to be mistaken is purposely made to be learned, reliability of the learning model can be increased by making the inference so as not to use that feature.

In FIG. 15 and FIG. 16, the learning object branch selection unit 41 selects learning object branches, to be made to execute the learning, by using the attention correct answer data. In this case, the type(s) of attention(s) stored in the attention correct answer data 42 and the branch(es) selected by the learning object branch selection unit 41 may have any one of a one-to-one correspondence, a one-to-many correspondence and a many-to-many correspondence. In cases of data for person detection, examples of the attention correct answer data 42 include heat map data in which the heat map is applied to the upper body, heat map data in which the heat map is applied to the lower body, heat map data in which the heat map is applied to the entire body, and so forth. For example, in cases of person detection, the learning object branch selection unit 41 may select branches that recognize the head or branches that recognize a part other than the head (e.g., the upper body or the lower body).

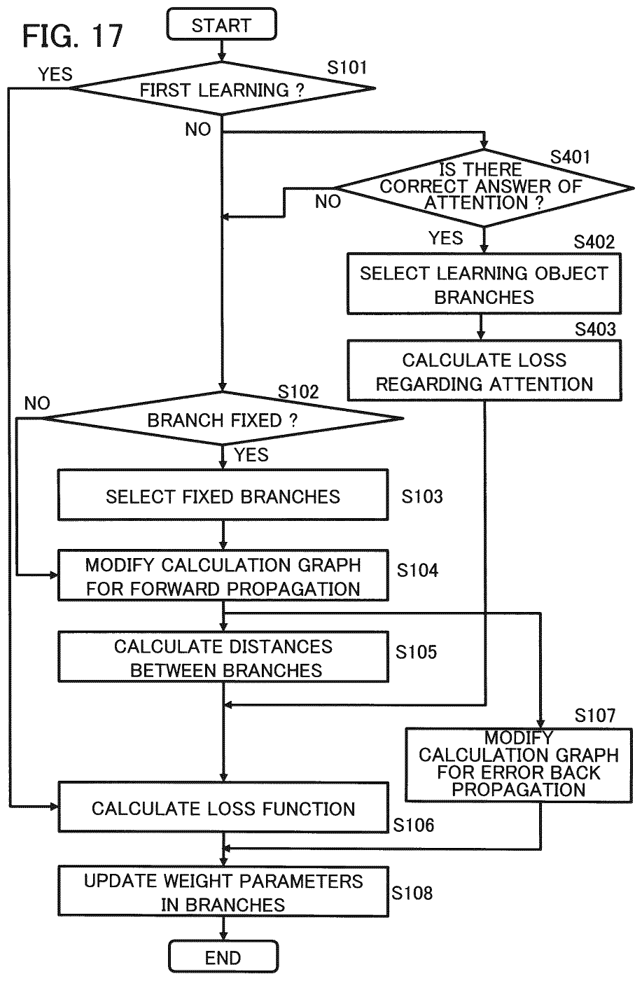

FIG. 17 is a flowchart showing the operation of the model learning device 4 according to the fourth embodiment at the time of model learning. In FIG. 17, each step identical or corresponding to a step shown in FIG. 8 is assigned the same reference character as in FIG. 8.

When there is the attention correct answer data 42 in the second or later learning (YES in step S401), the model learning device 4 makes the learning object branch selection unit 41 select the learning object branches (step S402), makes the attention loss calculation unit 43 calculate losses in regard to the selected learning object branches (step S403), and thereafter advances the process to the step S106, which differs from the operation of the model learning device 1 according to the first embodiment at the time of model learning.

In the fourth embodiment, the loss due to the attention is used only for the learning of the particular branch, and thus the error back propagation needs to be executed in multiple times as below, and the calculation graph to be used at that time is also memorized in regard to each of the multiple times of the error back propagation. Further, in the fourth embodiment, the loss dependent on the task and the distance loss dependent on the inter-branch distance calculation unit 11 can be error-back-propagated to all the learning object branches, and it is also possible to error-back-propagate the loss due to the attention only to the selected particular branch.

With the model learning device 4 according to the fourth embodiment, the branch visualization unit 15 visualizes the feature obtained by each branch by use of XAI, and thus the accuracy of the learning can be increased, by which the reduction of the memory use amount and the speeding up of the inference can be realized.

Further, the necessary number of times of the transfer learning can be reduced by preparing data of attention, in regard to data in which a feature likely to be mistaken is previously known, and having the data learned. Furthermore, in cases where such a feature likely to be mistaken is made to be learned, the reliability of the learning model can be increased by making the inference so as not to use that feature.

Except for the above-described features, the fourth embodiment is the same as the first embodiment. Further, it is also possible to apply the learning object branch selection unit 41, the attention correct answer data 42 and the attention loss calculation unit 43 in the fourth embodiment to the model learning device 2 or 3 in the second or third embodiment.

### DESCRIPTION OF REFERENCE CHARACTERS

1-4: model learning device, 10, 20, 30, 40: model learning unit, 11: inter-branch distance calculation unit, 12, 12c: loss function calculation unit, 13, 13a, 13b, 13c: calculation graph modification unit, 14: branch update unit, 15: branch visualization unit, 16: fixed branch selection unit, 21: branch addition unit, 31: branch deletion unit, 41: learning object branch selection unit, 42: attention correct answer data, 43: attention loss calculation unit, 101, 101a, 101b, 101c: processor, 102: storage, 103: interface.

What is claimed is:

1. A model learning device that executes transfer learning in regard to a learning model stored in storage, the model learning device comprising:
processing circuitry
to select fixed branches, as branches to be excluded from learning objects, from a plurality of branches included in the learning model;
to modify a calculation graph to be used into one of a first calculation graph that uses the plurality of branches and a second calculation graph that uses learning object branches obtained by excluding the fixed branches from the plurality of branches;
to calculate inter-branch distances, including distances between features respectively generated by each of the plurality of branches, in a state in which the calculation graph to be used has been modified to the first calculation graph;
to calculate a sum total of losses based on a predetermined loss function and the inter-branch distances; and
to update weight parameters in the learning object branches based on the sum total of losses in a state in which the calculation graph to be used has been modified to the second calculation graph.

2. The model learning device according to claim 1, wherein the processing circuitry visualizes the feature generated by each of the plurality of branches.

3. The model learning device according to claim 1, wherein the inter-branch distances include distances respectively between each of the features and the feature of a predetermined target branch in addition to the distances between the features respectively generated by each of the plurality of branches.

4. The model learning device according to claim 1, further comprising a user interface through which an operation for inputting identification information on the fixed branches is performed.

5. The model learning device according to claim 1, wherein the processing circuitry adds a new branch to the learning model.

6. The model learning device according to claim 1, wherein the processing circuitry deletes a fixed branch from the learning model.

7. The model learning device according to claim 1, wherein the processing circuitry selects the learning object branches from the plurality of branches based on previously generated correct answer data.

8. A model learning method to be executed by a model learning device that executes transfer learning in regard to a learning model stored in storage, the model learning method comprising:
selecting fixed branches, as branches to be excluded from learning objects, from a plurality of branches included in the learning model;
modifying a calculation graph to be used into one of a first calculation graph that uses the plurality of branches and a second calculation graph that uses learning object branches obtained by excluding the fixed branches from the plurality of branches;
calculating inter-branch distances, including distances between features respectively generated by each of the plurality of branches, in a state in which the calculation graph to be used has been modified to the first calculation graph;
calculating a sum total of losses based on a predetermined loss function and the inter-branch distances; and
updating weight parameters in the learning object branches based on the sum total of losses in a state in which the calculation graph to be used has been modified to the second calculation graph.

9. A non-transitory computer-readable storage medium storing a model learning program that causes a computer to execute transfer learning in regard to a learning model stored in storage, wherein the model learning program causes the computer to execute:
selecting fixed branches, as branches to be excluded from learning objects, from a plurality of branches included in the learning model;
modifying a calculation graph to be used into one of a first calculation graph that uses the plurality of branches and a second calculation graph that uses learning object branches obtained by excluding the fixed branches from the plurality of branches;
calculating inter-branch distances, including distances between features respectively generated by each of the plurality of branches, in a state in which the calculation graph to be used has been modified to the first calculation graph;
calculating a sum total of losses based on a predetermined loss function and the inter-branch distances; and
updating weight parameters in the learning object branches based on the sum total of losses in a state in which the calculation graph to be used has been modified to the second calculation graph.
